(19) United States
(12) Patent Application Publication
(10) Pub. No.: US 2015/0379882 A1
(43) Pub. Date: Dec. 31, 2015

(54) METHOD AND APPARATUS FOR MOTION TRACKING DURING SIMULATION OF CLINICAL EMERGENCY SETTINGS

(71) Applicant: Laerdal Medical AS, Stavanger (NO)

(72) Inventors: Valeria GAITÁN, Oslo (NO); Kjetil Lønne NILSEN, Stavanger (NO)

(73) Assignee: Laerdal Medical AS, Stavanger (NO)

(21) Appl. No.: 14/315,711

(22) Filed: Jun. 26, 2014

(51) Int. Cl. G09B 9/00; H04R 1/08; G09B 23/30

(52) U.S. Cl. CPC G09B 9/00; G09B 23/30; H04R 1/08

(57) ABSTRACT

An apparatus for motion tracking during a simulation of a clinical emergency setting includes a camera configured to capture a clinical emergency training area used for the simulation, a wearable microphone associated with a participant in the simulation, a wearable identifier associated with the participant, and a computer system interoperably coupled to the camera and the microphone and configured to capture data received during the simulation from the camera and data received during the simulation from the wearable microphone, process the data received from the camera and the data received from the wearable microphone, present visual traces indicative of position of the participant on a map of the clinical emergency training area as a function of time, and present audio derived from the wearable microphone in synchronization with the presented visual traces.

### TECHNICAL FIELD

The present invention relates to simulations of clinical emergency settings that are performed for training and learning purposes. One aspect of such simulations is a debriefing session after the simulation, wherein the performance of the team and each member of the team is evaluated. The debriefing session usually takes place immediately after the simulation has been completed. The team is exposed to their mistakes and strengths from their performance in order for them to improve their performance in the future.

### BACKGROUND

It is known to record medical simulations in order to watch film of the medical simulations in the debriefing session. In this manner, the team and their supervisor can look for errors, strengths, and possible improvements. Also, each team member can see how he or she performed. Watching the entire simulation is, however, time-consuming and hence the debriefing session is often not performed in a satisfactory manner or as often as would be ideal.

Systems exist that include high-fidelity cameras placed in a simulation room. Such systems capture simulation dynamics by embedding audio and video streams with a synchronized data log and patient monitor in a single debrief file. Debriefing will accurately replay scenarios and show what occurred during the simulation. Such systems often use a manikin with which actions are recorded through sensors in the manikin. As a result, these systems are not able to record such actions if the simulation is performed with an actor as a patient in lieu of the manikin.

### SUMMARY OF THE INVENTION

An apparatus for motion tracking during a simulation of a clinical emergency setting includes a camera configured to capture a clinical emergency training area used for the simulation, a wearable microphone associated with a participant in the simulation, a wearable identifier associated with the participant, and a computer system interoperably coupled to the camera and the microphone and configured to capture data received during the simulation from the camera and data received during the simulation from the wearable microphone, process the data received from the camera and the data received from the wearable microphone, present visual traces indicative of position of the participant on a map of the clinical emergency training area as a function of time, and present audio derived from the wearable microphone in synchronization with the presented visual traces.

A method of motion tracking during a simulation of a clinical emergency setting includes capturing video via a camera of a clinical emergency training area used for the simulation, the captured video comprising video of a participant wearing a unique wearable identifier, capturing audio via a wearable microphone associated with the participant, and a computer system interoperably coupled to the camera and the wearable microphone capturing data received during the simulation from the camera and data received during the simulation from the wearable microphone, processing the data received from the camera and the data received from the wearable microphone, presenting visual traces indicative of position of the participant on a map of the clinical emergency training area as a function of time, and presenting audio derived from the wearable microphone in synchronization with the presented visual traces.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a principle overview of a medical emergency simulation room having a manikin and a number of participants;

FIG. 2 is a principle view of the interaction between a ceiling-mounted camera and a simulation-session participant;

FIG. 3 is a graphic representation of movements of simulation-session participants;

FIG. 4 is a graphic representation corresponding to FIG. 3, but from another simulation session;

FIG. 5 is a graphic representation corresponding to FIG. 3, but showing only one participant;

FIG. 6 is a graphic representation similar to the one in FIG. 3, but also showing movement of medical equipment;

FIG. 7 is a screenshot of a debriefing-session presentation screen; and

FIG. 8 is a diagram that illustrates a computer system that can be employed in accordance with principles of the invention.

### DETAILED DESCRIPTION OF ILLUSTRATIVE EMBODIMENTS OF THE INVENTION

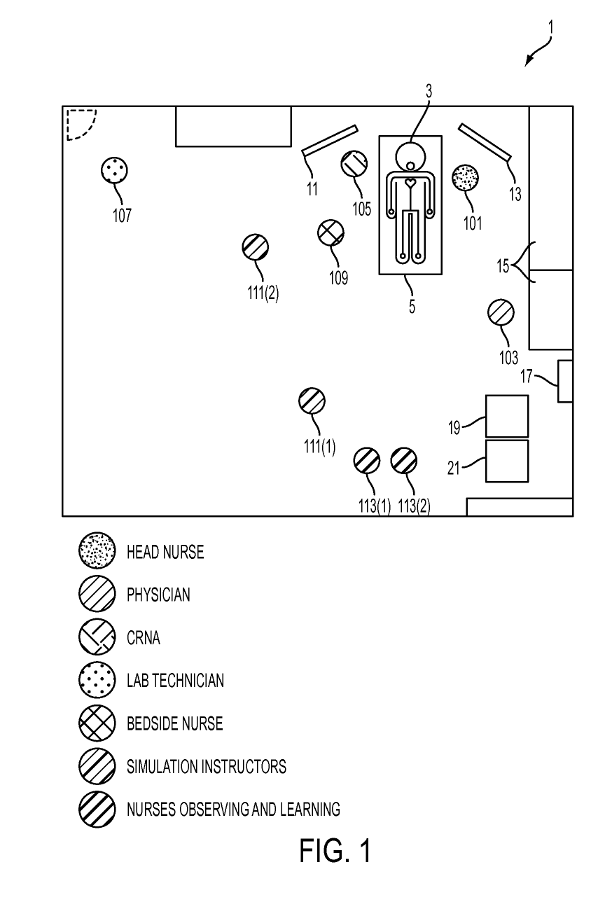

Referring now to the Figures, an upper portion of FIG. 1 schematically illustrates a medical emergency simulation room 1 as seen from above. Circular symbols shown in FIG. 1 represent various personnel in the medical emergency simulation room 1. Among these are simulation participants, including a head nurse 101, a physician 103, a CRNA (i.e., anesthesia nurse) 105, a lab technician 107, a bedside nurse 109, and simulation instructors 111(1) and 111(2). Also present in the medical emergency simulation room 1 are additional nurses 113(1) and 113(2), who are merely observing and learning (i.e., not participating in the simulation). Different circular-symbol and dashed-line patterns are used to distinguish different personnel in various of the Figures. In some embodiments, each of the different patterns may instead be replaced by a different color; however, given that black-and-white line drawings rather than color drawings are submitted as part of this patent application, no colors are shown in the Figures.

Also in the medical emergency simulation room 1 is a manikin 3 on a bed 5 and various equipment, including a first storage unit 11 storing, for example, a stethoscope, scissors, and a blood bag placement for infusion, a monitor 13, trauma equipment 15, gloves 17, documentation papers 19, and a second storage unit 21.

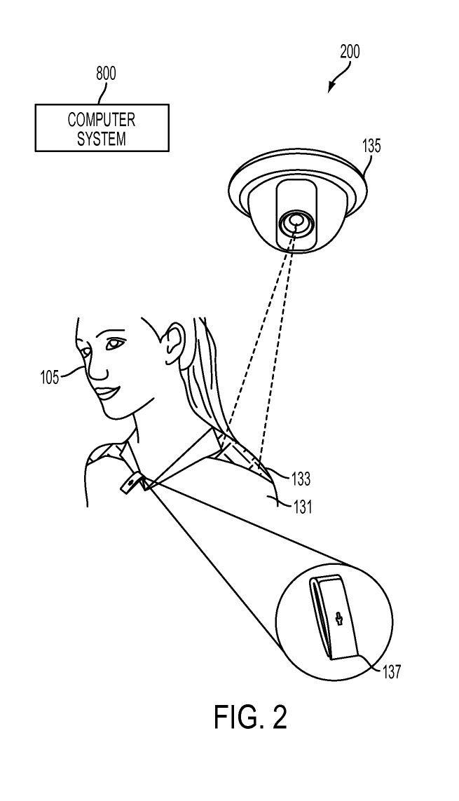

FIG. 2 illustrates a portion of a system 200. As part of the system 200, the CRNA 105 is wearing a jacket 131 provided with a code color section 133 on a shoulder area thereof. The code color section 133 is clearly visible from above so that a code color of the code color section 133 is visible to a ceiling-mounted camera 135 of the system 200. The ceiling-mounted camera 135 is mounted in such way as to have an overview of the medical emergency simulation room 1. In a typical embodiment, the ceiling-mounted camera 135 includes a wide-angle lens configured to capture an entirety of the medical emergency simulation room 1 without a need to pan or tilt.

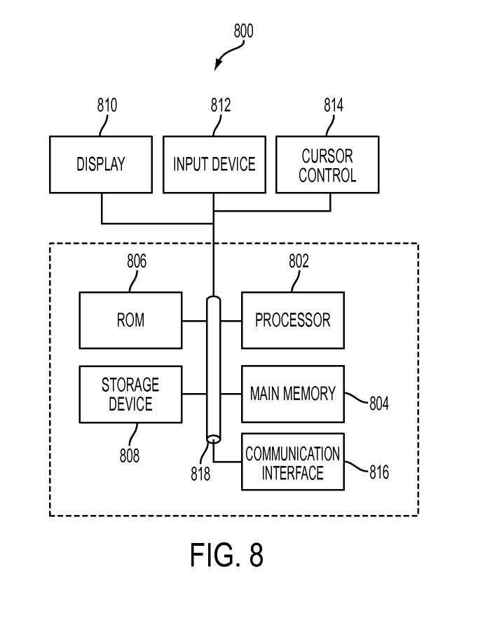

The camera 135 is connected to a computer system 800 with which the code color of the code color section 133 of the jacket 131 is recognizable. FIG. 8 provides more detail about a typical implementation of the computer system 800. Thus, the system 200 is able to track the position and also the movements of the CRNA 105.

Other participants of the simulation also wear a jacket 131; however, the jackets 131 of the other participants may be provided with code color sections 133 having different color codes. Thus, with the camera 135 and the computer system 800, positions and movements of all of the participants in the simulation can be recorded for a later debriefing session.

Instead of color coding the jackets 131, other solutions for tracking the motions of the participants can be employed. For instance, RFID transponders, the position of which can be tracked by appropriately positioned readers, may be used. Any other appropriate technology for identification of and tracking the motions of the participants can be used without departing from principles of the invention.

In a typical embodiment, the system 200 also includes a microphone 137 to be worn by one or more of the participants, such as the CRNA 105. The microphone 137 has a connection to the computer system 800, which connection is typically a wireless connection. In this manner, speech of the individual participants may be recorded. That is, typically all of, or at least a plurality of, the simulation participants wear a jacket 131 with the code color section 133 and a microphone 137.

As discussed above, with the camera 135 and the code color section 133 on the jackets 131, the computer system 800 can record the positions of the simulation participants.

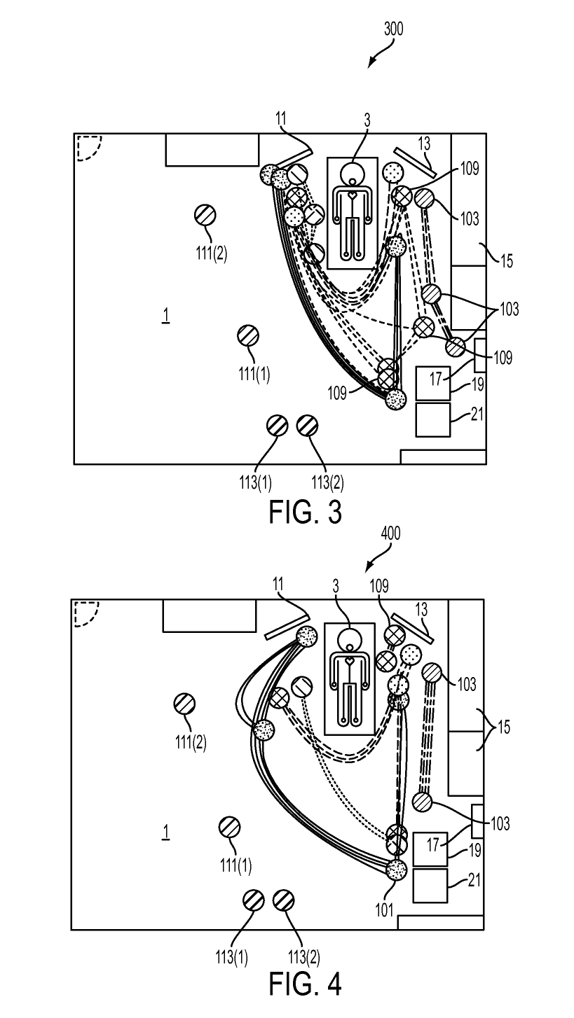

FIG. 3 illustrates a graphic representation 300 of a simulation session. As appears from the representation shown in FIG. 3, all of the participants have moved about between specific positions in the medical emergency simulation room 1. For instance, as shown in FIG. 3, the physician 103 has moved between three different positions on the right side of the medical emergency simulation room 1.

Of course, when moving around in a room, people often do not move in straight lines between various positions. Also, if standing on their feet, as in an emergency simulation session, their position in one place will not be constant. Thus, the graphic representation shown in FIG. 3 is an adjusted version of actual participant movement patterns. For instance, movement of the physician 103 between two positions has been recorded as an uneven and arbitrary line. The computer system 800 (or software stored in the computer system 800 or elsewhere) is configured to smooth out these movement lines in order to better represent the main movements of the participants. Moreover, if the physician 103 (or any other participant) remains for some time within a given area, this lack of substantial movement may be represented as a single circle, rather than as a plurality of real-life arbitrary small movements.

In a typical embodiment, the size of the circle that represents a continuous position of a participant depends on an amount of time during which the participant has remained in a particular position. That is, as a participant remains for some time in one position, the circle representing the participant will, for example, grow or become more intense in color. Thus, a large circle could be used to represent a participant who has stayed a long period at the position of the circle.

While FIG. 3 graphically represents a first simulation of one team of participants, FIG. 4 illustrates the same team and a second simulation session in a graphic representation 400. As can be seen, although the same participants have trained on the same scenario as in FIG. 3, there are differences in the movements of the participants.

Typically, after the first simulation session, as shown in FIG. 3, the participants will, together with an instructor, perform a first debriefing session before they perform a second simulation session. During the first debriefing session, each participant can study his or her own behavior on graphic representation 300.

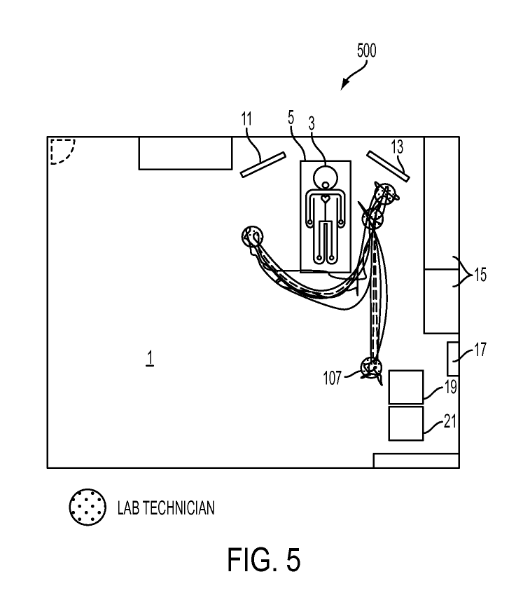

As an option, movements of only some of the participants, or only one participant, can be shown in the representation. FIG. 5 illustrates, for example, the movements of the lab technician 107 only in a graphic representation 500. The isolated representation of movement of the lab technician 107 makes it more feasible for the participant (lab technician 107 in this example) to study his own performance.

In FIG. 5, in order to illustrate the difference between the real movements of the participant (e.g., lab technician 107) and the presentation, an example of a real movement pattern of the lab technician 107 is shown over the smooth lines of the final presentation of the graphic representation 500.

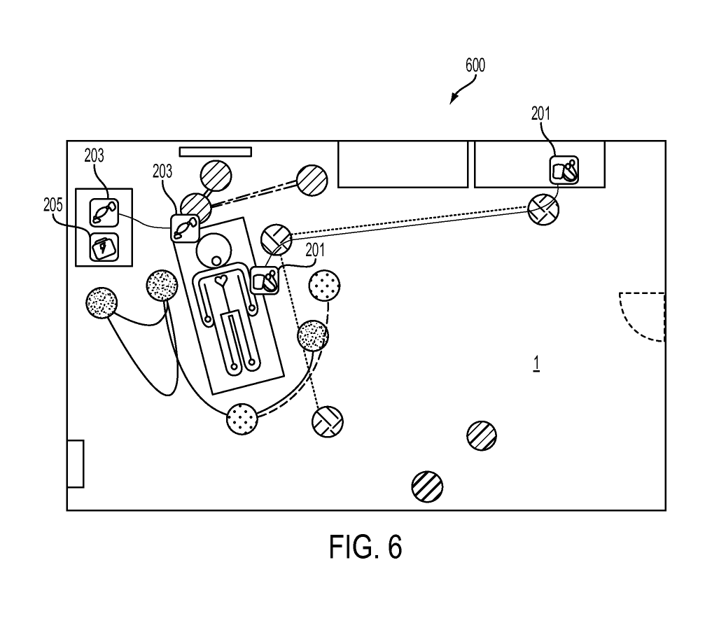

While FIGS. 3-5 illustrate the movement of the simulation participants in the medical emergency simulation room 1, FIG. 6 illustrates these movements in addition to movement of medical equipment in a graphic representation 600. In the graphic representation 600, three different pieces of medical equipment 201, 203, 205 are shown, of which two (201 and 203) were moved during the simulation session. The medical equipment movements may be tracked using any appropriate technology, including those described above to track motions of participants.

The tracking of medical equipment, as illustrated in FIG. 6, adds value to the debriefing session. For instance, during the debriefing session it may be discovered that a defibrillator 205 was picked up from its storage position before it was actually needed. Or, as another example, one could discover that the person using the defibrillator 205 was positioned on the opposite side of the manikin 3 and thus had to switch positions with another participant in order to use the defibrillator. In some embodiments, the medical equipment 201, 203, 205 can be linked in advance of the simulation to a particular participant, task, position in the medical emergency simulation room 1, or sequence of events during the simulation. In this way, it can be ensured, for example, that the medical equipment 201, 203, 205 is used by the correct participant, in the correct position in the medical emergency simulation room 1, or in the correct sequence of events during the simulation.

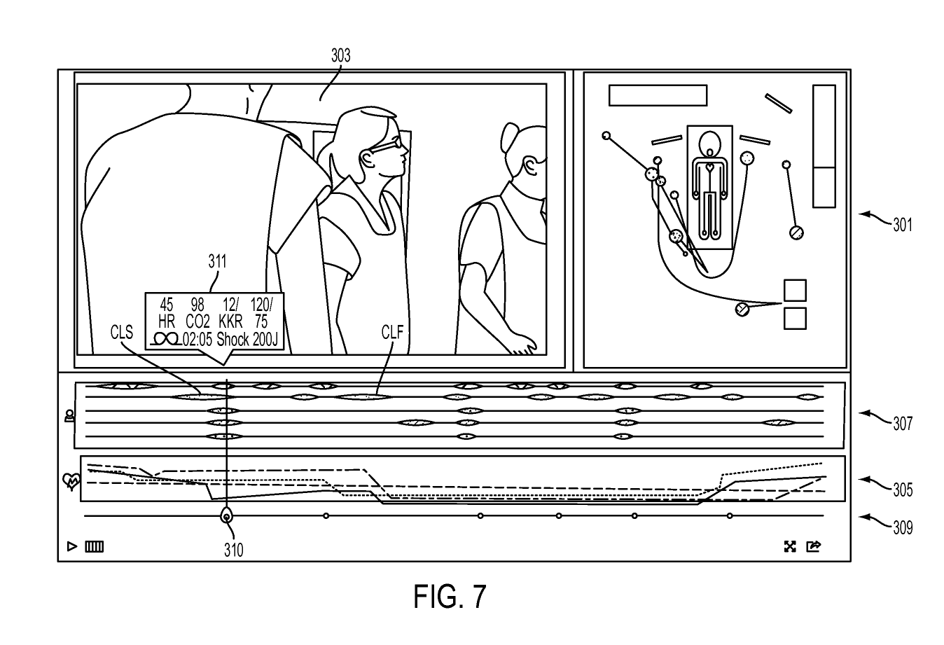

FIG. 7 illustrates a possible screen shot from a debriefing-session presentation. In the upper right portion of the screen, a graphic movement presentation 301 of the movements of the participants and possibly the equipment is shown. As above, different colors or patterns may be used to identify different personnel in the simulation. At the upper left portion, a film frame 303 showing a recorded film from the medical emergency simulation room 1 is displayed.

At the lower portion of the screen there are two sections extending widely horizontally. The lowermost section is a vital-signs section 305. The vital-signs section 305 presents vital signs of the patient (e.g., the manikin 3), such as, for example, heart rate, respiratory rate, temperature, and blood pressure.

Above the vital-signs section 305 is a verbal-communication section 307. In similar fashion to the above, different patterns or colors may be used to visually identify different personnel in the simulation. At least some of the participants may wear a microphone 137 (cf. FIG. 2). Thus, verbal communications can be recorded along with the movements and can be presented together in the screenshot depicted in FIG. 7. As appears from FIG. 7, use of voice of the participants results in a graphical presentation on the verbal-communication section 307.

Below the vital-signs section 305 is a time-selection bar 309, by means of which a desired time of the simulation session to be presented can be chosen. For instance, at the time chosen in FIG. 7, a time selector 310 is arranged on the time section bar at a specific point in time in the simulation session. At this moment, as depicted by one of the vital signs lines as well as by a vital signs value window 311, the heart rate was 45. As appears from the verbal-communication section 307, all the participants who are represented on the screen said something at this point in time.

In a typical embodiment, the system 200 includes a speech-recognition arrangement configured to recognize a plurality of words or phrases. The system 200 can also include a voice-recognition arrangement. For purposes of this patent application, speech recognition refers to recognition of particular words or phrases, while voice recognition refers to recognition of a particular person as a speaker. At the point of time chosen in FIG. 7, one participant is about to use the defibrillator. When using the defibrillator, the participants should practice closed-loop communication as a safety precaution for the participants. Closed-loop communication in this context means, for example, that before an electric shock is given with the defibrillator, the person performing the electric shock must alert the other participants, and all the participants must repeat or confirm the action to be taken before the electric shock can be given.

Another illustrative situation in which closed-loop communication should be used is when medication is to be administered. Typically, the leader will ask a nurse to apply a certain amount of a certain medication (e.g., 1 mg morphine). The nurse then repeats the type and amount of medication to be applied. In the end, the leader again repeats what he/she heard the nurse declare. Thus, in this example, closed-loop communication is employed in order to prevent giving wrong medicine and/or an erroneous dosage.

Thus, by means of the speech-recognition arrangement, the system 200 can detect use of words like types of medicine or use of the defibrillator. Thus, when the speech-recognition arrangement is employed, the system 200 can detect that the words have been repeated by other participants. If no such repetition is detected, it can be marked in the debriefing-session presentation.

If a voice-recognition arrangement is used, the system 200 can identify which participant is speaking. In some cases, a voice-recognition arrangement need not be utilized as such because the system merely identifies the loudest detected speech from a particular microphone 137 as speech from a participant with which that microphone 137 is associated. In some embodiments, if particular speech is detected by one or more of the microphones 137 and in other embodiments also by a separate room microphone located in the medical emergency simulation room 1 that is not associated with a particular participant, processing techniques can be used by the computer system 800 to determine which participant spoke a particular word or phrase. In other embodiments, one or more microphones not associated with any of the participants can be employed by the system 200 and processing undertaken by the computer system 800 to perform one or both of speech recognition and voice recognition of words or phrases spoken by the participants.

As an example, in some embodiments, a setup can be employed in which an alarm is triggered if the closed loop is not detected by the system 200. As an example, in FIG. 7, a point in time during the simulation session where a closed-loop communication is detected as successful is indicated by closed-loop success (“CLS”). A failed closed-loop communication is indicated by closed-loop fail (“CLF”).

With the solutions presented above, the debriefing session can, for example, in a period that is short compared to studying an entire film of the simulation session, present the following facts from the simulation session:
1. Interaction of the participants with the resources and/or equipment;
2. Communication among the participants;
3. Movements of the participants within the medical emergency simulation room 1;
4. Movement of equipment within the medical emergency simulation room 1.

Typical evaluated parameters include one or more of the following:
a) effective communication;
b) team leadership;
c) resource utilization;
d) problem-solving;
e) closed-loop communication;
f) situational awareness; and
g) distribution of tasks among participants.

FIG. 8 illustrates an embodiment of a computer system 800 on which various embodiments of the invention can be implemented. For example, the computer system 800 can be used as part of the system 200.

The computer system 800 may be a physical system, virtual system, or a combination of both physical and virtual systems. In the implementation, the computer system 800 may include a bus 818 or other communication mechanism for communicating information and a processor 802 coupled to the bus 818 for processing information. The computer system 800 also includes a main memory 804, such as random-access memory (RAM) or other dynamic storage device, coupled to the bus 818 for storing computer readable instructions by the processor 802.

The main memory 804 also may be used for storing temporary variables or other intermediate information during execution of the instructions to be executed by the processor 802. The computer system 800 further includes a read-only memory (ROM) 806 or other static storage device coupled to the bus 818 for storing static information and instructions for the processor 802. A computer-readable storage device 808, such as a magnetic disk or optical disk, is coupled to the bus 818 for storing information and instructions for the processor 802. The computer system 800 may be coupled via the bus 818 to a display 810, such as a liquid crystal display (LCD) or a cathode ray tube (CRT), for displaying information to a user. An input device 812, including, for example, alphanumeric and other keys, the camera 135, and the microphone 137, is coupled wirelessly or via wired connection to the bus 818 for communicating information and command selections to the processor 802. Another type of user input device is a cursor control 814, such as a mouse, a trackball, or cursor direction keys for communicating direct information and command selections to the processor 802 and for controlling cursor movement on the display 810. The cursor control 814 typically has two degrees of freedom in two axes, a first axis (e.g., x) and a second axis (e.g., y), that allow the device to specify positions in a plane.

The term “computer readable instructions” as used above refers to any instructions that may be performed by the processor 802 and/or other component of the computer system 800. Similarly, the term “computer readable medium” refers to any non-transitory storage medium that may be used to store the computer readable instructions. Such a medium may take many forms, including, but not limited to, nonvolatile media, volatile media, and transmission media. Non-volatile media include, for example, optical or magnetic disks, such as the storage device 808. Volatile media includes dynamic memory, such as the main memory 804. Transmission media includes coaxial cables, copper wire, and fiber optics, including wires of the bus 818. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EPROM, any other memory chip or cartridge, or any other medium from which a computer can read.

Various forms of the computer readable media may be involved in carrying one or more sequences of one or more instructions to the processor 802 for execution. For example, the instructions may initially be borne on a magnetic disk of a remote computer. The remote computer can load the instructions into its dynamic memory and send the instructions over a telephone line using a modem. A modem local to the computer system 800 can receive the data on the telephone line and use an infrared transmitter to convert the data to an infrared signal. An infrared detector coupled to the bus 818 can receive the data carried in the infrared signal and place the data on the bus 818. The bus 818 carries the data to the main memory 804, from which the processor 802 retrieves and executes the instructions. The instructions received by the main memory 804 may optionally be stored on the storage device 808 either before or after execution by the processor 802.

The computer system 800 may also include a communication interface 816 coupled to the bus 818. The communication interface 816 provides a two-way data communication coupling between the computer system 800 and a network. For example, the communication interface 816 may be an integrated services digital network (ISDN) card or a modem used to provide a data communication connection to a corresponding type of telephone line. As another example, the communication interface 816 may be a local area network (LAN) card used to provide a data communication connection to a compatible LAN. Wireless links may also be implemented. In any such implementation, the communication interface 816 sends and receives electrical, electromagnetic, optical, or other signals that carry digital data streams representing various types of information. The storage device 808 can further include instructions for carrying out various processes for image processing as described herein when executed by the processor 802. The storage device 808 can further include a database for storing data relative to same.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. An apparatus for motion tracking during a simulation of a clinical emergency setting, the apparatus comprising:
a camera configured to capture a clinical emergency training area used for the simulation;
a wearable microphone associated with a participant in the simulation;
a wearable identifier associated with the participant;
a computer system interoperably coupled to the camera and the microphone and configured to:
capture data received during the simulation from the camera and data received during the simulation from the wearable microphone;
process the data received from the camera and the data received from the wearable microphone;
present visual traces indicative of position of the participant on a map of the clinical emergency training area as a function of time; and
present audio derived from the wearable microphone in synchronization with the presented visual traces.

2. The apparatus of claim 1, wherein the wearable identifier comprises at least one of a color-coded item and an RFID tag worn by the participant.

3. The apparatus of claim 1, wherein the computer system is configured to perform speech recognition based, at least in part, on data derived from the wearable microphone.

4. The apparatus of claim 3, wherein the computer system is configured to perform voice recognition.

5. The apparatus of claim 1, comprising:
a wearable microphone associated with a second participant in the simulation;
a wearable identifier associated with the second participant; and
wherein each of the wearable microphones and each of the wearable identifiers is uniquely associated with a particular participant in the simulation.

6. The apparatus of claim 5, wherein the computer system is configured to perform speech recognition based, at least in part, on data derived from the wearable microphone associated with the participant and on data derived from the wearable microphone associated with the second participant.

7. The apparatus of claim 6, wherein, responsive to recognition of a particular word or phrase, the computer system is configured to detect the presence or absence of closed-loop communication between the participant and the second participant.

8. The apparatus of claim 7, wherein the computer system is configured to trigger an alarm based on the detection of the absence of closed-loop communication between the participant and the second participant.

9. The apparatus of claim 7, wherein the computer system is configured to perform voice recognition.

10. The apparatus of claim 5, wherein the wearable visual identifier associated with the participant is a first color and the wearable visual identifier associated with the second participant is a second color.

11. The apparatus of claim 10, wherein a visual trace associated with the participant is the first color and a visual trace associated with the second participant is the second color.

12. The apparatus of claim 1, comprising:
an identifier associated with an object in the clinical emergency training area; and
wherein the computer system is configured to present a visual trace indicative of position of the object on the map as a function of time.

13. The apparatus of claim 12, wherein the object is a manikin used in the simulation.

14. The apparatus of claim 12, wherein the object is medical equipment used in the simulation.

15. The apparatus of claim 14, wherein the medical equipment is linked in advance of the simulation to at least one of a particular participant, task, position in the clinical emergency training area, and sequence of events.

16. A method of motion tracking during a simulation of a clinical emergency setting, the method comprising:
capturing video via a camera of a clinical emergency training area used for the simulation, the captured video comprising video of a participant wearing a unique wearable identifier;
capturing audio via a wearable microphone associated with the participant;
a computer system interoperably coupled to the camera and the wearable microphone:
capturing data received during the simulation from the camera and data received during the simulation from the wearable microphone;
processing the data received from the camera and the data received from the wearable microphone;
presenting visual traces indicative of position of the participant on a map of the clinical emergency training area as a function of time; and
presenting audio derived from the wearable microphone in synchronization with the presented visual traces.

17. The method of claim 16, wherein the wearable identifier comprises at least one of a color-coded item and an RFID tag worn by the participant.

18. The method of claim 16, comprising the computer system performing speech recognition based, at least in part, on data derived from the wearable microphone.

19. The method of claim 18, comprising the computer system performing voice recognition.

20. The method of claim 16, comprising:
wherein the captured audio comprises captured audio of a second participant wearing a wearable microphone;
wherein the captured video comprises captured video of a second participant wearing a unique wearable identifier; and
wherein each of the wearable microphones and each of the wearable identifiers is uniquely associated with a particular participant in the simulation.

21. The method of claim 20, comprising the computer system performing speech recognition based, at least in part, on data derived from the wearable microphone associated with the participant and on data derived from the wearable microphone associated with the second participant.

22. The method of claim 21, comprising, responsive to the computer system performing speech recognition of a particular word or phrase, the computer system detecting the presence or absence of closed-loop communication between the participant and the second participant.

23. The method of claim 22, comprising the computer system triggering an alarm based on the computer system having detected the absence of closed-loop communication between the participant and the second participant.

24. The method of claim 22, comprising the computer system performing voice recognition.

25. The method of claim 20, wherein the wearable identifier associated with the participant is a first color and the wearable identifier associated with the second participant is a second color.

26. The method of claim 25, wherein a visual trace associated with the participant is the first color and a visual trace associated with the second participant is the second color.

27. The method of claim 16, comprising:
wherein the captured video comprises captured video of a unique identifier associated with an object in the clinical emergency training area; and
the computer system presenting a visual trace indicative of position of the object on the map as a function of time.

28. The method of claim 27, wherein the object is a manikin used in the simulation.

29. The method of claim 27, wherein the object is medical equipment used in the simulation.

30. The method of claim 29, comprising linking the medical equipment in advance of the simulation to at least one of a particular participant, task, position in the clinical emergency training area, and sequence of events.
